(19) United States
(12) Patent Application Publication
(10) Pub. No.: US 2003/0065428 A1
(43) Pub. Date: Apr. 3, 2003

(54) Integrated aircraft early warning system, method for analyzing early warning data, and method for providing early warnings

(76) Inventors: Ehud Mendelson, Plantation, FL (US); Smadar Mort, Coral Springs, FL (US)

Correspondence Address: LERNER AND GREENBERG, P.A., POST OFFICE BOX 2480, HOLLYWOOD, FL, 33022-2480, US

(21) Appl. No.: 10/213,410

(22) Filed: Aug. 5, 2002

Related U.S. Application Data
(60) Provisional application No. 60/326,145, filed on Oct. 1, 2001.

(51) Int. Cl. G06F 17/00; G06F 7/00

(52) U.S. Cl. 701/9; 701/3

(57) ABSTRACT

Methods and system for recording data from an aircraft and alerting with a wireless network are disclosed. The methods contain receiving signals containing data from a plurality of aircraft, determining normal thresholds for the data, monitoring and analyzing the data, and generating an alert signal if the data is beyond the thresholds with a ground based computer terminal in real time. The system includes a ground computer and other mechanisms for implementing the disclosed method.

### CROSS-REFERENCE TO RELATED APPLICATIONS

This application claims the benefit under 35 U.S.C. §119(e) of provisional application No. 60/326,145, filed Sep. 21, 2001.

### BACKGROUND OF THE INVENTION

### FIELD OF THE INVENTION

The present invention lies in the field of aircraft warning systems. More specifically, the invention relates to warning systems and methods for providing warnings of various types of flight hazards.

Today, flight data recorders (FDR) and cockpit voice recorders (CVR), known as “black boxes”, are the only two devices aboard a commercial aircraft configured and used to collect and store voice and flight data for retrieval (in the event of an accident) for purposes of investigation and analysis by the proper federal authorities. The CVR acquires conversations of pilots and cockpit sounds on a tape. The FDR records engine performance and changes in the flight speed and position. In many instances, the “black boxes” are destroyed or lost and no data can be retrieved.

Flight recorders were introduced in the late 1950s. The devices became known as black boxes, and the name endured even after the government required airlines to paint the boxes bright orange to make them easier to locate after a crash.

The modern recorders employ flash-memory chips, which can store data for several years without the need for power. The best solid-state recorders can hold about 80 megabytes, which is much less than the memory of most personal computers, but enough to store two hours of voice recordings from the cockpit or a full day worth of recordings of the instruments on the plane.

These recorders also contain circuit boards that process and compress the data, but only the memory chips are enclosed in the crash-survivable unit (inside the box). The unit is covered with a thick steel armor so that it can withstand a crushing impact shock. Beneath the steel, there is a layer of thermal insulation protecting the memory chips from high-temperature fires that often occur after a jet accident.

Modern black boxes are far more capable and crashworthy than earlier models, but the Federal Aviation Authority (FAA) is still seeking improvements. The FAA recently expanded the list of instrument readings, which must be stored in flight data recorders. The FAA also has proposed to equip each cockpit voice recorder with a backup power supply so that the CVR can continue recording even if the aircraft electrical systems fail.

While the cockpit voice recorder (CVR) and the flight data recorder (FDR) are useful, they have some problems. When investigating an accident, it is necessary to search and clean large areas to retrieve rubble, which is used to reconstruct the accident scene, as an aid in determining the cause of the accident. The present invention significantly reduces the time and effort to perform the investigation.

Another problem with current flight hazard warning systems results because the aircraft are equipped with several separate systems. This makes it very difficult to integrate the operations.

In recent years, there have been a number of developments in flight data recorders. U.S. Pat. No. 4,729,102, which is incorporated by reference herein, discloses a flight data recorder system, which monitors a number of aircraft parameters and compares them to stored information to provide more efficient aircraft operation and detection of excessive wear. The information is displayed and stored on-board and may be downloaded periodically via a link to a ground readout unit.

U.S. Pat. No. 5,463,656, which is incorporated by reference herein, discloses a system for broadcasting full broadcast quality video to airplanes in flight via satellite relays. The system includes video bandwidth compression, spread spectrum waveform processing and an electronically steered, circular aperture, phased array antenna that conforms to the surface of the aircraft.

U.S. Pat. No. 5,467,274, which is incorporated by reference herein, discloses a method of recording selected flight data, including GPS data, onto a VTR and thereafter subjecting the recorded data to a data reduction process on the ground.

U.S. Pat. No. 5,325,302, which is incorporated by reference herein, discloses an aircraft collision warning system, which includes a position determining subsystem, a trajectory determining subsystem, a collision predicting subsystem and a warning device.

Finally, U.S. Pat. No. 5,383,133, which is incorporated by reference herein, discloses a computerized, integrated, health monitoring and vibration reduction system for a helicopter.

The disclosed state of the art does not contemplate that there is no need to replace the existing black boxes.

### SUMMARY OF THE INVENTION

It is accordingly an object of the invention to provide an integrated aircraft early warning system, a method for analyzing early warning data, and a method for providing early warnings that overcome the above-mentioned disadvantages of the prior art devices and methods of this general type.

Due to the enormous number of concurrent flights and the enormous data flow, the biggest problem is analyzing the flow of the information and the invention accomplished this via an on-ground alarming system that will display the problematic flight as a flight-animation on a ground monitor. The camera and video units are optional. The data is transferred on-line and analyzed on-line via satellite communications.

With the foregoing and other objects in view there is provided, in accordance with the invention, an aircraft flight hazard collection and warning system which includes logic for a number of individual flight hazard warning systems implemented in a central computer that also includes logic to resolve conflicts between concurrent alert signals generated by the different warning systems.

A system is provided for analyzing on-line data information that transmits via satellite communication from the aircraft to a ground central location. The “early warning system” is a solution to the most demanding problem in aviation security today. The value of data is in how it is manipulated to provide information of value-intelligence to a decision-maker. Pilots and air traffic controllers need to make critical timely decisions to support individual and team tasks. To make their jobs safer and easier, the data must be managed to provide intelligence.

Considering the requirements placed on pilots today, the data must be managed to provide information and intelligence. The limited ability of pilots to react to incremental data elements will compromise his or her ability to form an effective decision based on the “human error factor”. Transforming the data into information will help support the development of situational knowledge and ultimately lead to decisions or solutions concerning the task at hand.

One of the drawbacks for any collected information database is information overload. For example, in any instant, there are so many concurrent flights (more then 5000) to be monitored and the job task makes it almost impossible.

The FAA has already recommended installing video cameras on-board aircraft. But the FAA did not enforce it. One official questioned how authorities would simultaneously monitor the videos of up to 5,000 planes in flight. “How many people would you need to hire just to watch the TV screens?”, the official asked. The invention solves this problem. It needs only a few people to view the alarming screen, and, for the first time, both the pilot and the ground personnel can see the same—it's as if the invention puts the ground pilot in the cockpit.

The invention focuses on converting data to decisions. It uses the data not only to investigate, but also to prevent disasters.

The invention does not replace the “black box” or add additional sensors on-board of the aircraft. Rather, it does make the “black box,” what it should be—a backup.

The benefits to both commercial and military aircraft are self-evident. With the use of the invention some of the recent air disasters that have occurred on United States soil and abroad may have been avoided, and in cases where the black boxes were damaged beyond recovery or the data stored was unrecoverable, the airline and government would both have a digital record of all the events in all situations in no time.

Using the system, the cause of a questionable disaster can in most cases be determined and maybe avoided. The resulting information will show if there was an explosion in the aircraft, terrorist activity, or any mechanical failure instantly. The transmission of data is conducted instantly to the ground, and no time is lost in data recovery. The invention puts the ground pilot (monitor) in the cockpit.

In the tragic wake of an airline crash, one of the highest priorities of the accident investigators is to retrieve the black boxes. The Federal Aviation Administration requires all large commercial aircraft to be equipped with two such devices: the cockpit voice recorder, which records the voices of the flight crew and other sounds in the cockpit, and a flight data recorder, which monitors altitude, airspeed, heading and other instrument readings of the aircraft. Because the information can be vital to the investigation of an air disaster, the recorders must be configured so that the stored data can survive virtually any crash.

After September 11th almost any aviation crash is suspected to be a terrorist incident and the effect on normal life all, especially at airports and to travelers are enormous. The slow recovery of recorder information, in some instances, has resulted in a lot of pressure being placed on authorities while awaiting recorder retrieval.

In turn, the demand for corrective measures has arisen, some typical concerns being: what if the event had been a terrorist incident? The nature of terrorism is that it tends to be repeated, and it is vital that any possibility of its occurrence is confirmed promptly and appropriate measures be taken. For some time after the TWA event there was intense speculation as to its cause and any crash after September 11th is initially categorized as a terrorist act. The prompt view of the on-line information from the inventive “early warning system” could have made a significant difference in that investigation. Had the cause of the accident really been terrorism the authorities would have the information in no time and would have allowed authorities to take preventative measures not to mention to save millions of dollars.

If it takes several days to recover a recorder, is there a possibility of one being utterly lost? Incidents such as that of September 11th or the case of a midair breakup over the ocean where the exact location of the aircraft is difficult to track and ensuing debris is dispersed over a wide expanse of ocean several miles deep make the recovery of the black box all but impossible. If the search extends beyond the 30-day lifetime of the ultrasonic locator beacon the recorders might never be found. Again, the benefit of using the inventive “Early warning system” is self-evident, the authorities will have all the information in real-time and no time and money are needed to find the “black box”.

A major aircraft manufacturer predicts that air accidents will reach the rate of one a week in the near future simply as an extrapolation of increases in air traffic. Although it is also the goal of airworthiness authorities to proportionally improve statistical air safety, it will remain to be seen if this is achieved.

The additional incidents will put a higher workload on air accident investigation authorities. Already, due to limited budgets, investigators regularly choose not to investigate some minor events. To date, it is rare that compromises are been made between full investigation and none at all. The availability of an “early warning system” may then save the authority, and in turn taxpayers, the multi million dollar bill for recovering the equipment.

This latter approach is currently favored by some military authorities, where in the case of a fighter aircraft pilot ejecting from an aircraft for known reasons, the ready availability of the recorder data can provide a formal record of an incident and economically provide closure to it.

In the mid 70's there was no CNN to show the horrors of an accident. The ones who suffered were the families of the victims. The airline and the manufactures of airframe and engines had their own problems. The airlines realized that they needed an insight in the day-to-day operation. Terms like quality emerged.

The more information you have the better decisions you are able to make. Or, we may even go as far as saying the more intelligence you have the better you are able to understand a problem and be proactive. Intelligence in a military sense is the gathering of information. Comparing information, double-checking, looking for patterns and deviation (from peacetime) norm. Isn't that exactly what we want to do? Look for patterns, look for deviation from an established norm and finally do a risk analysis.

FOQA programs use in-flight recorded data to determine the flight path of an aircraft from takeoff to landing. But, the real value of FOQA is turning the in-flight recorded data into meaningful and useful information. Information that evaluates and audits the quality of flight training programs, standard operating procedures, quantifying risk, quality of management, ATC flight guidance, cockpit workload, etc. The only problem is that it's done after the flight. In the case that there is a crash there is no information.

It is all in the in-flight recorded raw data. And the invention will eliminate that problem and will save the airlines money for the FOQA program.

The data can be used to prevent disasters in addition to investigating disasters.

By the processing of in-flight recorded data ON-LINE we can provide information of the cockpit and the aircraft environment, adequate changes can be made to minimize risk and prevent accidents. Accidents are caused less by failures of the machine and more by the performance failures of man. Is it possible to measure cockpit environment and workload? The raw data processing is mainly a background program that takes care of all processing requirements.

The “Early Warning System” is a uniquely configured system that allows for the extraction of information such as “what-if” and queries of a large number of events stored in the system. The system uses high fidelity visualization and simulation whenever feasible, to display a situation or an analysis. “The early warning system” is 3-dimentional. The visualization and simulation can be used to display and replay Allied Signal Enhanced Ground Proximity Warning events using a photo realistic animation. The system also assesses risk to flight operation on a daily basis and determines the probability of a reoccurrence of detected events.

Risk analysis is a process that includes risk assessment and risk management. Risk assessment is identifying hazards to a flight that may lead to an accident or at some point during flight will cause an unwanted situation that may lead to an accident. Risk is characterized in qualitative or quantitative terms. This includes the probability of an occurrence. Risk management is the process within risk analysis that includes identifying, evaluating and implementing alternatives for mitigating risk.

How is this done? We need all the in-flight recorded raw data to determine what environment the pilots have in the cockpit.

One of the major issues from the September 11th attacks were problems relating to the transponder. During the hijacking, the transponder was disabled by the hijackers. One lesson from the attacks of September 11th is the importance of ensuring continuous transponder communication with air traffic control (ATC) following a hijacking. Without the transponder switch in a fully active position, ATC can track an aircraft only by primary radar, which does not indicate aircraft identity and altitude. The loss of this information causes other aircraft to lose awareness of the flight in progress.

The invention of the instant application solves this problem too, all the information about the aircraft including its active position and all the data will be transferred automatically to the ground without any option of interfering or disabling with the flow of information. By using the invention, there is no need for an additional transponder or any modification.

The milestones could be by actions by the pilots in connection with the guidance of the ground crew or could be maneuvering of the aircraft in accordance with instructions given to the auto flight system for automatic control from the ground. It provides the option for remote operation of the aircraft from the ground.

In recent years there have been a number of developments in flight data recorders. However, none of these developments is the answer to the most problematic issue—analyze the huge flow of information that needed a huge number of people just to watch and monitors the events, the invention solves this problem.

Some of the key unique features of the invention are now discussed. The invention uses technology that was development recently after September 11th. Recently, there is development that will allow broadband bandwidth via global satellite communication between moving aircraft and the ground and will not depend on the low bandwidth two-way radio frequency (RF) network that airlines use today. RF bandwidth has a limited data transfer rate of 9.6 kb-19.2 kb and additional limitations over the ocean. The invention uses real broadband bandwidth of 56 kb and up and it can be done only via global satellite network communications and not by RF or a wireless cellular network.

The invention will require the installation of a new flat satellite antenna aboard the aircraft. The proprietary solid-state-phased-array receive and transmit antenna is the key enabler for the two-way broadband communications. The phased array antenna steers beams electronically, permitting instantaneous connections between satellites and mobile platforms such as aircraft.

The increase in bandwidth will also enable airlines to extend Internet, low cost telephone (VOIP) and facsimile services on board the aircraft at a substantial savings over existing telephone services. The income derived from these new low cost services will far exceed the cost of implementing the invention. Therefore, the invention is a no cost option as it will derive greater fees than it incurs.

The invention does not intend to replace the black boxes, rather the black boxes are used as a backup.

The invention does not require the need for additional sensors to be install onboard the aircraft. Furthermore, the invention provides a simple and faster solution that can be implement using existing hardware that have already been approved by the FAA.

And again none of the developments in the black boxes have the “aircraft integrated early warning” concept, i.e. to be able to emulate the exact situation of the aircraft and by alerting the ground crew when there is a problem aboard the aircraft or manually trigger by the pilot. It's like putting the ground pilot in the cockpit.

The big pay back in flight safety, as well as cost savings, does not come from post flight analysis but only comes from using this data in real-time application programs that are targeted at accident prevention. The real time programs that share safety data will result in dramatic increases in air capacity, safety, security and operational efficiency.

Simple shared safety advisories and the warning of problems, are only inserted into displays when there are potential and existing problems, and will significantly improve safety and situation awareness while decreasing workloads. The safety alerts would only come on during potential and existing problems and or pilot manually triggering the alarm.

Once alerts come on in a plane, there is a lot of voice communication that takes place, between the flight crew and the traffic controllers that can easily be misunderstood. It also puts stress on both the pilot and the controller, depletes precious reaction time and increases their workloads.

A simple emergency low fuel safety icon can automatically be displayed on the ground monitor, similar to the low fuel warning light on automobiles, to alert the controller of the dangerous low fuel status. The low fuel warning light or oil pressure warning lights in an automobile doesn't increase the workload of the driver but simply increases the situation awareness and prevents catastrophic failures. Once a ground crew receives a warning light he can then set the landing priorities to expedite a safe landing.

The invention updates the federated system and unifies the communications approach so that the relevant data parameters are globally visible and readily available for timely and cost effective problem resolution. It is a system engineering approach that potentially can eliminate or minimize the need for the costly and time intensive recovery of the recorder of the aircraft. With the invention, the existing FDR is a redundant system that essentially eliminates the need to recover it, in all but a very small percentage of the crashes. By so doing, it also eliminates the need to routinely post flight download the recorder for FOQA data.

The FOQA data will automatically and securely be disseminated, at essentially no cost, to the proper people. The “early warning system” is for enhanced air space capacity, passenger safety, security and operational efficiency. It utilizes existing state-of-the-art communications, computer and software technology to unify the total avionics system and use the existing hardware and technology available today.

The system information is brought out of an archival database and into a real-time usable on-line aircraft integrated early warning system. In addition, it ends the information vacuum created by the aircraft and air traffic controller, where presently each acting independently, does not have the necessary measurement sensors that are required to prevent a crash. This information vacuum has compromised the safety net and is the major cause of the stagnant air carrier fatal accident rate. It has led to a situation where currently air travel is over nine times more lethal than bus travel, and over three times more lethal than car travel. In addition it is now fifteen times more lethal to be a passenger on a commercial airliner than it is to be a passenger on the space shuttle.

The space shuttle and un-man aircraft utilize a real time ground based global monitoring, recording, simulation and expert advisor system to make flights safe. In this day and age, this proven safety technology can be harnessed and utilized for commercial air travel. This will drastically reduce the fatal accident rate as well as make air travel more economical and secure.

By the cooperative combining of the aircraft and ground data, and thus sharing the safety parameters in real time, the situation is enhanced and the system can now anticipate many types of crashes.

This crash anticipation capability provides the visibility and time necessary for the prevention of fatal accidents. Furthermore, by the global transmission of the data to a ground processing and distribution station, it provides a best estimate of a downed aircraft position for timely search and rescue operations. It also minimizes and eventually can eliminate the need for the costly and time intensive recovery of the flight recorder.

The system unifies the aircraft communications information system. It provides that the data is securely transmitted via satellite, to assure that the relevant data parameters are globally visible and readily available to the people who need them in order to timely and optimally solve problems in a cost-effective manner prior to them becoming accidents.

Furthermore, it optimizes the safety net and adds a level of redundancy to the present and planned sub-optimal capacity and safety systems, which are prone to single thread failures. The system alleviates a broad spectrum of operational efficiency, air space capacity and air safety problems. The system provides the safety net that should be in place in commercial and even military aircrafts and is not limited to aircraft alone; it can be use for trains, ships, big tracks, etc..

The present invention collects such information (flight data and cockpit voice) and transmits it to a remote location (on the ground) in real time. In addition, the system collects live images from the cockpit and the cabin and transmits them.

Accordingly, the novel system and procedure provide the ability to record on-line related events (e.g., flight data, cockpit voice, and cockpit and cabin images) aboard the aircraft, and to transmit the information in real time to a remote location on the ground. State of the art encryption ensures complete security and safety to all transmitted information.

The system is installed aboard the aircraft and contains a flight data recorder (an existing FDR can be used), a cockpit voice recorder (an existing CVR can be used), and a sub-system including a set of miniature state of the art video cameras, strategically installed in critical locations in the cockpit and in the cabin together with an image recorder. The sub-system is new and collects video images from the cockpit and the cabin in real time.

All the information that is collected and recorded by the flight data recorder, the cockpit voice recorder, and the sub-system is transferred to a compression multiplexer, which compresses all the information and data, and sends it in real time to an on-ground, secured, storage facility. Then, the information is recorded on a removable, industry-based drive for storage and retrieval.

The compression multiplexer may send the information to the storage facility via a satellite communication system, on-board sky phone lines, and/or via a wireless cellular system.

The system of the present invention works in conjunction with the existing flight data recorder and cockpit voice recorder (the “black boxes”), and receives all the information and data concurrently. The system has the ability to display, the information collected, on a dedicated display monitor on board the aircraft, and concurrently on the ground in real time to authorized airline and/or federal personnel.

Accordingly, the system allows the proper authorities to assess any irregular situation aboard the aircraft in real time and thereby take any necessary action faster (due to possessing real and live information) than conventionally possible.

The system also enables the authorities to investigate and debrief any improper activity, incident or accident, and eliminates the need to wait, search for and retrieving the “black boxes,” which frequently become useless due to damage or loss.

In addition, the system can be used on any other modes of public transportation, such as ships, boats, trains, buses, under-ground railroad systems, public buildings and places of mass gatherings.

Whereas conventional recorders merely record data during flight (to be post-analyzed in the lab), if and after they are found, (usually after the crash), the present invention allows analyzing data, voice and on-demand video pictures during the flight and generates graphical displays of flight data while recording it. The ability to analyze data during flight and to see a full color digital image, as it appends, will make the “black boxes” redundant (or to be used as backups).

The computer-based recorders of the invention perform data analysis and graphical display, while concurrently recording multi-source flight data (onto digitally formatted files) that will be sent on line to a secure ground storage location via satellite bandwidth connections (i.e., the media). On the ground, an automatic alert system will allow immediate access (by using advanced software) to the data and interrogate, display, report and distribute any event; this will advantageously reduce the workforce needed to monitor all flights all the time.

Thus, the device and methods of the present invention provide the ability to on-line record/display, to remote locations, all the events on an aircraft.

Accordingly, the system will show a photo-realistic instrument panel and selectable critical instruments by showing the data in a format that puts the ground pilot in the cockpit for the first time, that is both of them will “see” the same data.

The benefits that the present invention provides to commercial and military aircrafts are enormous. By using the invention, some of the air disasters that could occur can be avoided; and in cases, where the black boxes were damaged beyond recovery (or the data stored were unrecoverable), both the airline and government would have a digital record of all the events in all situations.

Further, the causes of questionable disasters can, in most cases, be determined. The resulting information will show if there was a terrorist activity, an explosion in the aircraft or any mechanical failure. The transmission of data is conducted instantly to the ground, and no time is lost in data recovery.

The system unifies the air space communications information system. The system securely provides aircraft data via satellites ensuring that the relevant data parameters are globally visible and readily available to the people needing the data, in order to timely and optimally solve problems, in a cost-effective manner before an accident takes place.

Furthermore, the system optimizes the safety net and adds a level of redundancy to the current and planned sub-optimal capacity and safety systems, which are prone to single thread failures. The system alleviates a broad spectrum of operational efficiency, air space capacity and air safety related problems.

By processing the in-flight recorded data on-line, the system can provide information on the cockpit and the aircraft environment, and adequate changes can be made to minimize risk and prevent accidents.

Raw data processing is a backend program that takes care of the processing requirements. The “Early Warning System” is a uniquely configured system that allows the extraction of information, such as “what-if” and queries of a large number of events stored in the system. The system uses high fidelity visualization and simulation whenever feasible, to display a situation or an analysis. The early warning system is 3-dimensional in nature. The visualization and simulation programs can be used to display and replay “AlliedSignal Enhanced Ground Proximity Warning” events using a photo realistic terrain database.

The system also assesses the risk to a flight operation on a daily basis and determines the probability of the reoccurrence of the detected events.

Turning now to reducing risks, “risk analysis” is a process that includes risk assessment and risk management. Risk assessment includes identifying hazards to a flight that may lead to an accident, or, that will cause an unwanted situation that may lead to an accident. Risk is characterized in qualitative or quantitative terms. This includes the probability of an occurrence. Risk management is the process within risk analysis that includes identifying, evaluating and implementing alternatives for mitigating risks.

The system gathers all the in-flight recorded raw data to determine what environment that the pilots have in the cockpit. The targets are set based on the actions of the pilots in connection with the guidance of the ground crew or are based on the maneuvering of the aircraft in accordance with instructions given to the auto-flight system. The system tremendously assists the remote operation of the aircraft from the ground.

Moreover, the cockpit voice recorder is of limited value to an analyst looking for latent problems. The CVR only records the last 30 minutes of the flight. The flight data recorder, however, records flight parameters for a much greater time period. That is, normally for around 75 hours. When, due to high workloads, the normal interaction between the captain and co-pilot is degraded, the risk of an accident can become unacceptably high. By analyzing flight guidance, on-line determination may be made as to why, under certain conditions, cockpit workloads are high. Also, the determination of casual factors can be made, and action, via training, procedures and system-design, can be taken to prevent future accidents.

However, the present invention realizes that great rewards in flight safety and cost savings, do not come from post-flight analysis, but come from using the data in real-time application programs that are targeted at accident prevention. The real-time programs that share safety data will realize dramatic increases in air capacity, safety, security and operational efficiency.

Shared safety advisories and warnings of problems, after being incorporated into displays (when there are potential and existing problems), will significantly improve the safety and situation-awareness while decreasing workloads.

All the events parameters records on the “black box” like a simple emergency low fuel safety icon can automatically be displayed on the ground monitor animation (similar to the low fuel warning light on automobiles) to alert the controller of the dangerous status. The low fuel warning lights or oil pressure warning lights in an automobile do not increase the workload of the driver, but simply increase the situation awareness and prevents catastrophic failures. Once the ground crew receives a warning light, the ground crew can expeditiously set landing priorities to expedite a safe landing.

The system information is brought out of an archival database and into the real-time usable accident prevention system. In addition, the system eliminates the information gap between the aircraft and air traffic controller, whereas presently each acting independently, do not have the necessary measurement sensors that are required to prevent a crash. The information gap has compromised the safety net, and is the major cause of the stagnant air carrier fatal accident rates.

By the strategic combination of the aircraft and ground data analysis, and, thus, sharing the safety parameters in real time, the effectiveness is enhanced and the system can now anticipate many types of crashes. The crash anticipation capability provides the visibility and time necessary for the prevention of fatal accidents.

Furthermore, via the global transmission of data to a ground processing and distribution station, the system provides a better estimate of a downed aircraft's position for timely search and rescue operations. The system also minimizes and eventually can eliminate the need for the costly and time-consuming recovery of the flight recorder.

Referring to transponders, a transponder is a wireless communications, monitoring or control device that picks up and automatically responds to an incoming signal. Simple active transponders are employed in location, identification, and navigation systems for commercial and private aircraft. An example is a radio-frequency-identification device (RFID) that transmits a coded signal when it receives a request from a monitoring or control point.

The transponder output signal is tracked, so that the position of the transponder can be constantly monitored. The invention provides continuous transmission of an aircraft signal, even if the transponder were turned off.

Accordingly, the present invention provides the following advantages:

complete solution—combines airborne digital recorder of voice data and video with extensive analysis, reporting and distribution software accessible ON LINE;

monitors multiple flight data sources concurrently;

computer-based and reliable components;

removable industry-based drives for storage media;

records full traffic, not limited to the black box memory limitation, and uses available storage space efficiently;

lightweight and small (important in aircraft);

configured, built and tested for harsh environmental conditions;

advanced complementary data analysis, reporting and distribution software;

automatic alert system alerts the ground crew for events even before the flight crew knows about the events;

displays monitored units data in real-time; and

reduces workforce needed to view and monitor flight events.

The novel system and techniques, of the invention, enable monitoring and analysis on-line of events and automatically alerts when changes in normalcy occurs, thereby reducing the number of the ground crew needed.

Moreover, during hijacking and terrorist activities, the terrorists can disable the transponder. Ensuring continuous transponder communication with air traffic control (ATC) following a hijacking is critical. Without the transponder switch in a fully active position, ATC can only track an aircraft by the primary radar, which does not indicate aircraft identity and altitude. The loss and absence of this information causes other aircrafts to lose awareness of the flight in progress.

The invention solves this problem because all the recorded information regarding the aircraft includes the active position information, and all the data will be transferred automatically to the ground without any provision for interfering with or disabling the flow of information. This is done without any need for any additional transponders or modifications.

Other features which are considered as characteristic for the invention are set forth in the appended claims.

Although the invention is illustrated and described herein as embodied in an integrated aircraft early warning system, a method for analyzing early warning data, and a method for providing early warnings it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1 and 2 are block diagrams of a system for capturing, transmitting and recording data from an aircraft and alerting with a wireless network, according to the invention;

FIGS. 3-5 are illustrations further showing the system for capturing, transmitting and recording data from the aircraft and alerting with a wireless network; and

FIG. 6 is a cockpit display displayed to ground personal on a monitor; and

FIGS. 7A-7D are flow charts for explaining multiple methods according to the invention.

### DESCRIPTION OF THE PREFERRED EMBODIMENTS

In all the figures of the drawing, sub-features and integral parts that correspond to one another bear the same reference symbol in each case.

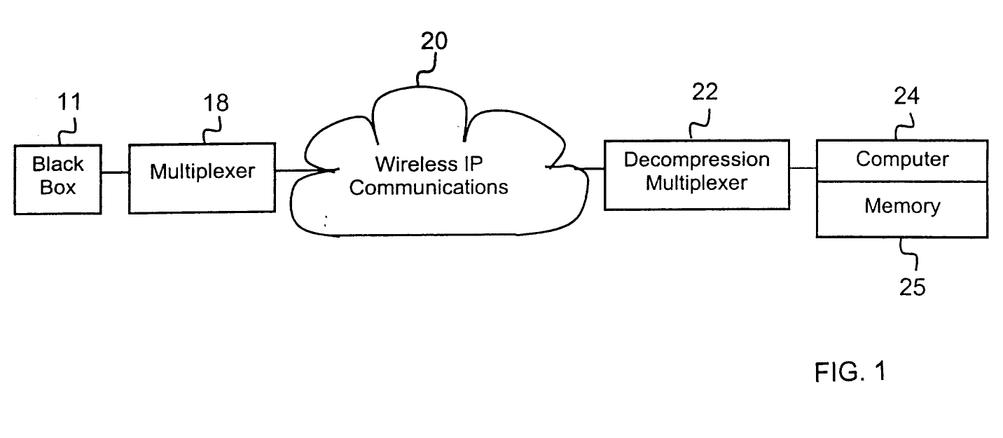

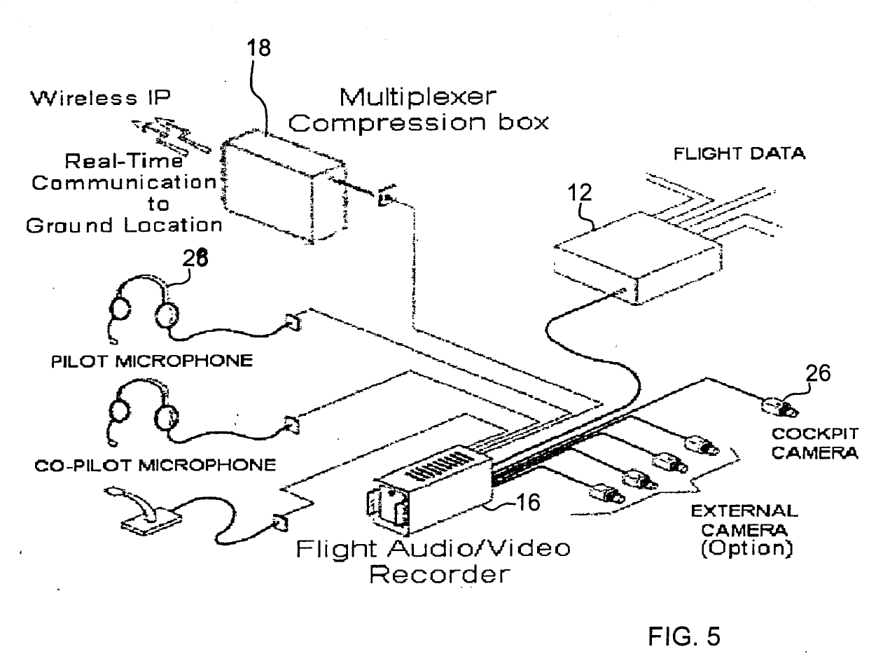

Referring now to the figures of the drawings in detail and first, particularly to FIGS. 1-5 thereof, there is shown a diagram of a system for capturing, transmitting and recording data from an aircraft and alerting with a wireless network, according to the invention. Although the invention is illustrated with an aircraft, other types of vehicles may also be used, such as trains, ships, boats, helicopters, trucks, buses and metro-systems, to name a few.

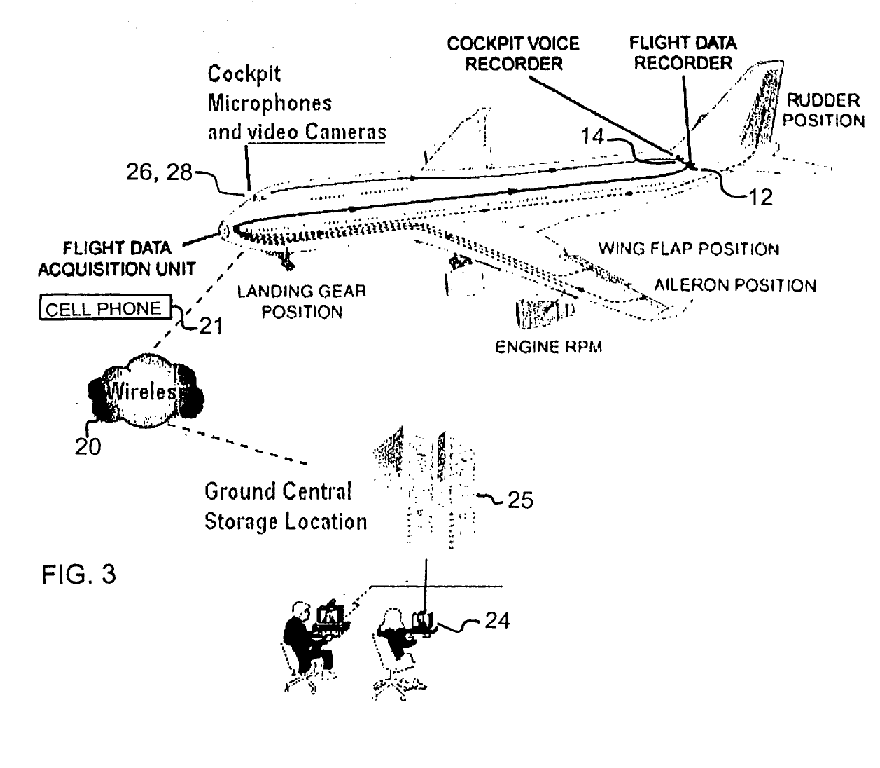

The system includes a conventional black-box 11 (or black boxes) containing a flight data recorder 12 for recording fight data parameters and a cockpit voice recorder 14 for recording cockpit voice (FIGS. 1 and 3). The flight data recorder 12 records flight information such as velocity, altitude, fuel, engine RPM, rudder position, wing flap position, aileron position, location, and landing gear positions to name just a few operating parameters that are recorded.

The system may also include a video/audio recorder 16 for recording sound and video on the aircraft, and an audio/video/data multiplexer compression gateway 18, which encrypts and compresses and sends the information over a wireless Internet protocol (IP) communication network 20. At a ground control location, a decompression multiplexer unit 22 is provided to process and convert and decompress the incoming on-line information to a readable-format, which can be stored on a digital standard storage device of a ground computer 24. The ground computer 24 is connected to the Internet protocol (IP) communication network 20, and has a digital storage device 25 and a monitor that can be viewed anytime.

Thus, the air-to-ground communications are implemented via the wireless broadband/IP/satellite communications network 20/38.

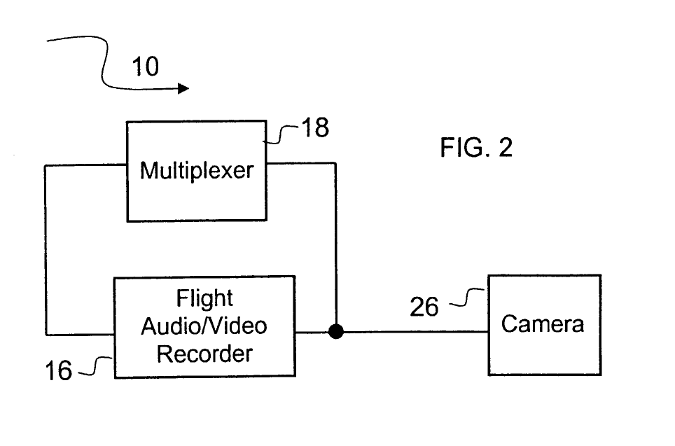

Referring again to FIG. 2 in detail, the system includes a transmission unit 10. The transmission unit 10 contains the audio/video recorder 16 and at least one video camera 26, which are strategically disposed in the aircraft. The unit 10 further includes the on-board compression multiplexer 18 coupled to the audio/video recorder 16.

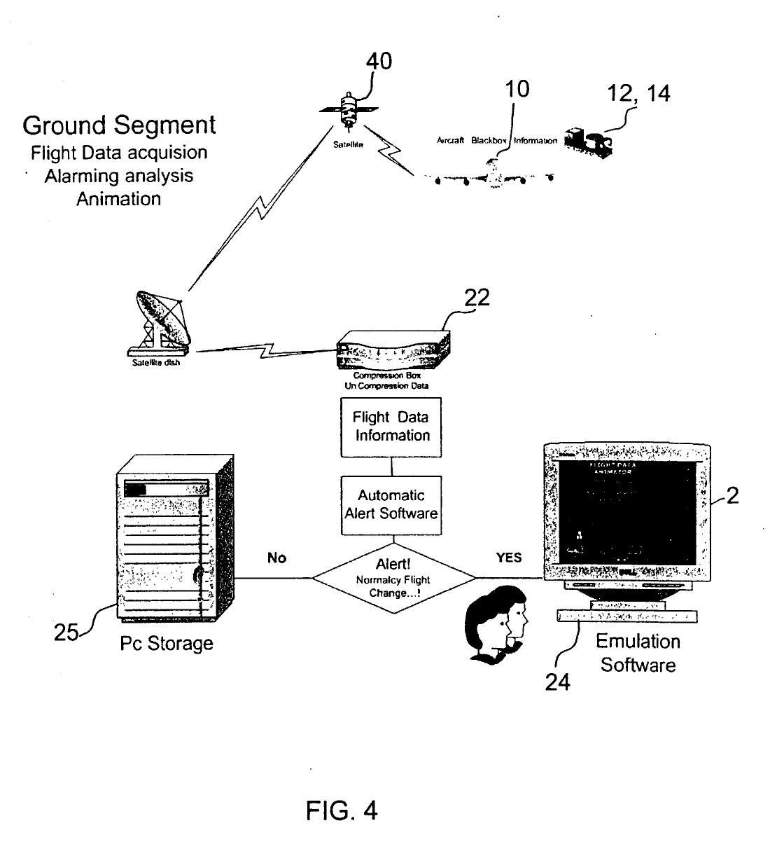

The system further contains at least one satellite 40 in a satellite network 38, which communicates with the transmission unit 10 (FIG. 4). The system also contains the flight data recorder 12 and the cockpit voice recorder 14, which are coupled to the transmission unit 10.

The system may include a microphone 28, coupled to the transmission unit 10, to generate or modulate electric currents for transmitting and recording sounds. Further, the ground computer 24 and the storage device 25 are coupled to the transmission unit 10 in real time. The storage device 25 may also be implemented as a part of the ground computer 24.

The system may also contain the on-ground decompression multiplexer 22, which is coupled to the transmission unit 10, for decompressing the received-data on ground.

The software for the system may include “raw data processing”, a backend program, which takes care of the processing requirements. It may also include an “Early Warning System”, a uniquely configured program that allows the extraction of information, such as “what-if” and queries of a large number of events stored in the system. The system uses high fidelity visualization and simulation, whenever feasible, to display a situation or an analysis on line live as emulate the pilot front panel. The early warning system is 3-dimensional in nature.

The software for the system includes “Visualization and Simulation Programs”, which are used to display and replay “Allied Signal Enhanced Ground Proximity Warning” events using a photo realistic terrain database.

The system may also assess the risk to a flight operation on a daily basis and determine the probability of the reoccurrence of the detected events.

Turning now to reducing risks, the software may also include “risk analysis”, a program that includes “risk assessment” and “risk management” modules. “Risk assessment” includes identifying hazards to a flight that may lead to an accident, or, that will cause an unwanted situation that may lead to an accident. Risk is characterized in qualitative or quantitative terms. This includes the probability of an occurrence. Risk management is the process within risk analysis that includes identifying, evaluating and implementing alternatives for mitigating risks.

The system gathers all the in-flight recorded raw data to determine what environment the pilots have in the cockpit. The targets could be set based on the actions of the pilots in connection with the guidance of the ground crew or could be based on the maneuvering of the aircraft in accordance with instructions given to the auto-flight system. The system tremendously assists the remote operation of the aircraft from the ground.

Turning now to the methods of the invention, when a change in the aircraft operations occurs, an automatic system alarm is triggered as explained below.

The system of the present invention is in full operation all the time and sends the information to the ground computer 24 with the ground storage device 25 located at the central storage location. The system may be activated for on-line monitoring as follows:

(i): the ground control staff may turn on the computer 24 and receive all the black box information, in a real-time streaming format, about the aircraft, including data, video and voice to the central computer 24; and/or

(ii): the central computer 24 may be automatically activated to alert the ground staff upon detecting abnormal situations, or be triggered manually by the pilot, for example, when the plane leaves a predetermined flight-path for any reason or when there is a sudden drop in altitude.

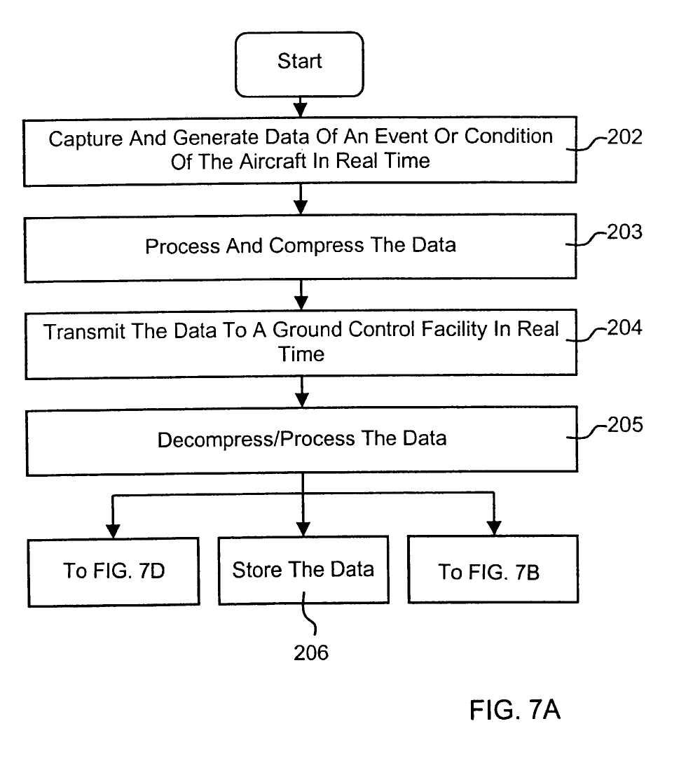

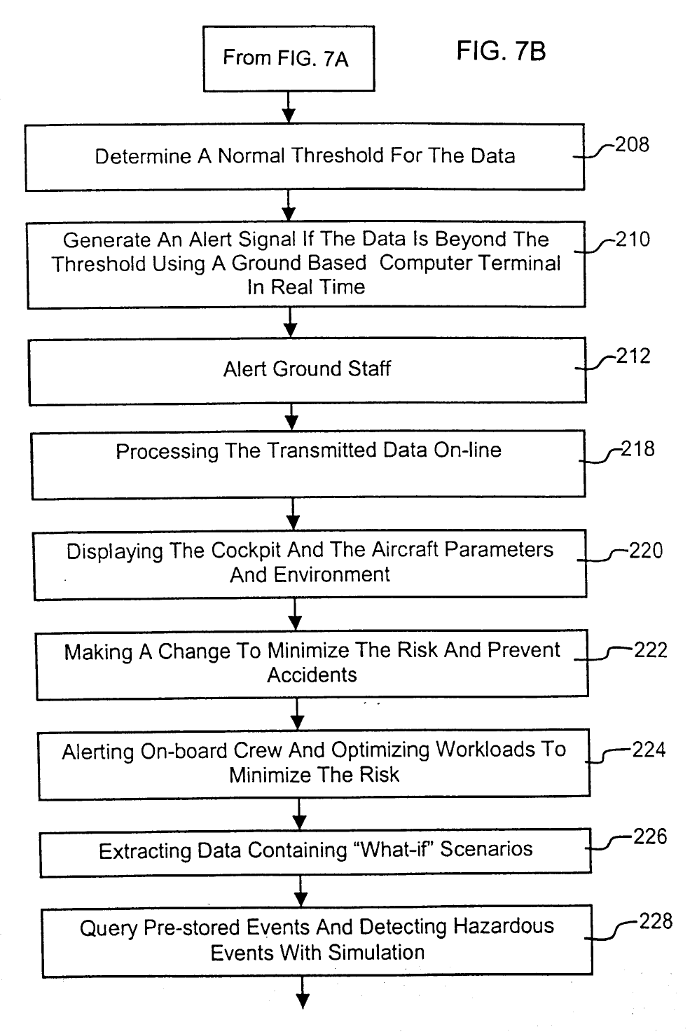

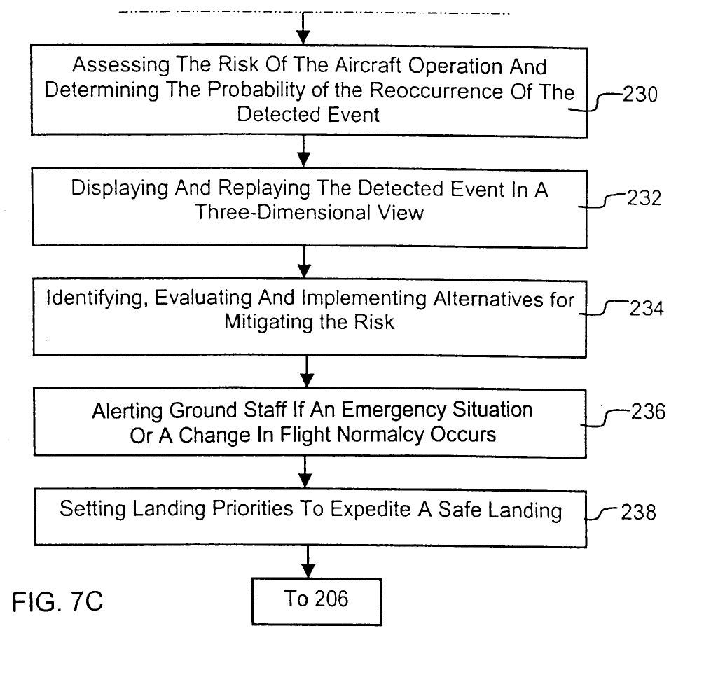

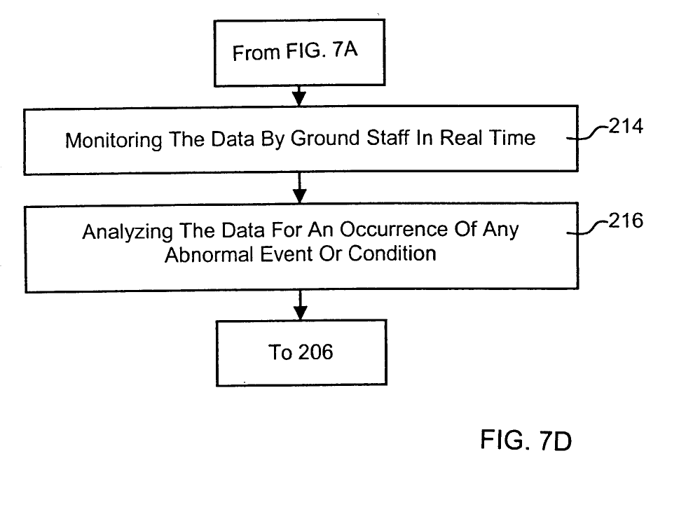

FIGS. 7A-7D show the flow of the steps for the methods according to the invention.

At step 202, the system (specifically, the camera 26, FDR 12, CVR 14 and audio/video recorder 16) captures and generates audio and video data of an event or condition of the aircraft in real time. At step 203, the compression multiplexer 18 processes and compresses the data.

At step 204, the transmission unit 10 transmits the data to the ground control facility in real time via the wireless/IP/satellite network 20/40. At step 205, the decompression multiplexer 22 processes and decompresses the received data. At step 206, the storage device 25 stores the data.

FIG. 7B shows the method for automatically alerting the staff. At step 208, the ground computer 24 determines a normal threshold for all data parameters. At step 210, the computer 24 generates an alerting signal in real time, if the data is beyond the normal threshold with the aid of the ground-based computer terminal 24. At step 212, the alerting signal alerts the ground staff.

In this manner, a single computer system can monitor multiple aircraft at a time and alert an operator when normal operating thresholds are exceeded on any given aircraft. Therefore, a single operator can monitor multiple aircraft, and when requested or alerted, aircraft information can be displayed to the operator on the monitor of the central computer 24. The data may be transmitted to the ground control facility computer 24, which is connected to the WWW in an Internet environment.

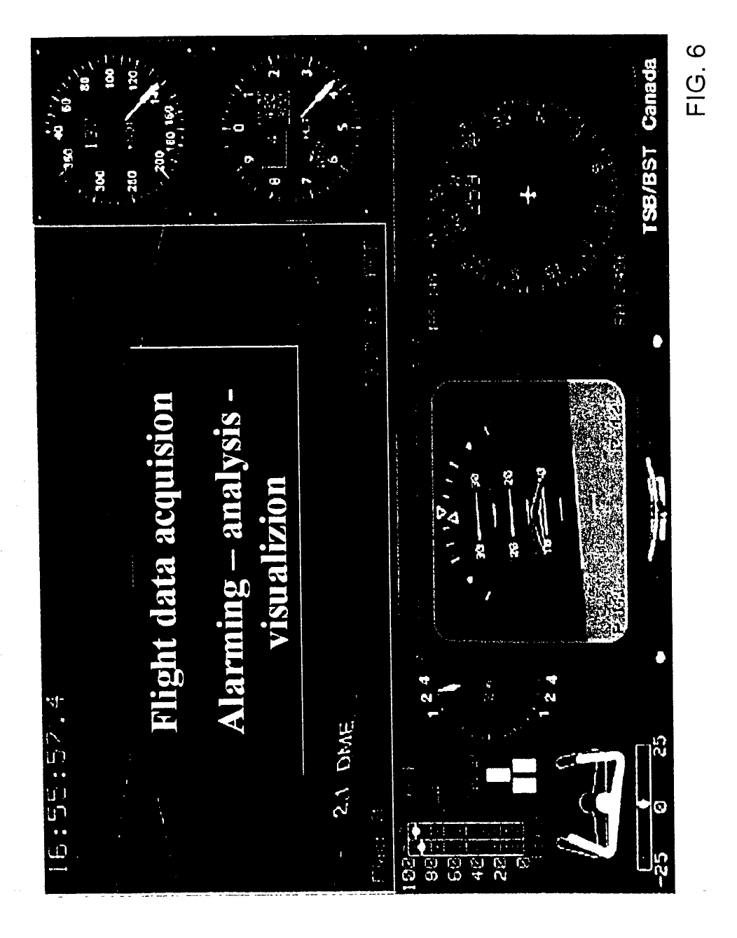

The method also may include processing the transmitted data on-line, displaying the cockpit and aircraft parameters and environment on a ground control monitor, and making a change to minimize the risk and prevention of accidents. In addition, the monitor can display or simulate the aircraft displays so as to put the ground personal in the environment of the pilot (FIG. 6).

FIG. 7D shows the manual version of the method according to the invention. At step 214, the ground staff monitors the received data in real time with the aid of the computer 24. At step 216, the staff analyzes the data for any occurrences of an abnormal event or condition to prevent disasters.

At step 218, the transmitted data is processed on-line. Step 220 performs displaying the cockpit and the aircraft parameters and environment. At step 222, the staff makes an appropriate change to minimize the risk and prevent an accident. At step 224, the ground staff can alert the on board crew, change and optimize the workloads of the on-board crew to minimize the risk of accidents.

The method may include extracting data containing “what-if” scenarios (at step 226), querying several pre-stored events and detecting a hazardous event using simulation (at step 228), and assessing the risk of the aircraft operation and determining the probability of the reoccurrence of the detected event (at step 230).

The method may also include displaying and replaying the detected event in a three-dimensional view (at step 232), identifying, evaluating and implementing alternatives for mitigating the risk (at step 234), alerting ground staff if an emergency situation (i.e. low fuel) occurs or a change in normalcy occurs (at step 236), and setting landing priorities to expedite a safe landing (at step 238).

Thus, the present invention provides systems, mechanisms, and methods for monitoring and analyzing real-time events, on-line, for automatically alerting when changes in normalcy occur, thereby eliminating the need for additional transponders and also reducing the number of the ground crew needed. Therefore, there is no longer a need to recover the black boxes, should any aircraft accident occur. In addition, a real-time evaluation of situations aboard aircraft can be evaluated and responded to.

In other embodiments, hard-wired circuitry may be used with software instructions to implement the invention, in addition to a computer-readable medium. Thus, embodiments of the invention are not limited to any particular combination of hardware and software.

The term “computer-readable medium” refers to any medium that provides instructions. Such a medium may include but not be limited to, non-volatile media, volatile media, and transmission media. Non-volatile media includes, optical and magnetic disks. Volatile media may include dynamic memory.

Common forms of computer-readable media include a floppy disk, flexible disk, hard disk, magnetic tape, and any other magnetic medium, a CD-ROM or other optical mediums, and a RAM, a PROM, and EPROM, a FLASH-EPROM, other memory chips, and any other medium from which a computer can read.

We claim:

1. A method for operating an aircraft early warning system, which comprises:
processing transmitted data on-line;
displaying cockpit, aircraft, and environmental parameters; and
making a change to minimize risk and prevent accidents.

2. The method according to claim 1, which comprises alerting an on-board crew-member and optimizing workloads to minimize the risk.

3. The method according to claim 1, which comprises:
extracting further data containing “what-if” scenarios;
querying a plurality of pre-stored events and detecting a hazardous event with simulation; and
assessing a risk of an aircraft operation and determining a probability of a reoccurrence of a detected event.

4. The method according to claim 3, which comprises displaying and replaying the detected event in a three-dimensional view.

5. The method according to claim 3, which comprises identifying, evaluating and implementing alternatives for mitigating the risk.

6. The method according to claim 1, which comprises alerting ground staff if an emergency situation occurs.

7. The method according to claim 6, which comprises setting landing priorities to expedite a safe landing.

8. A computer readable medium having program instructions for performing a method for providing aircraft early warnings, comprising:
processing transmitted data on-line;
displaying cockpit and aircraft parameters and environment; and
making a change to minimize a risk and prevent accidents.

9. The computer readable medium of claim 8, further comprising further program instructions for alerting an on-board crew and optimizing workloads to minimize the risk.

10. The computer readable medium of claim 8, further comprising further program instructions for:
extracting further data containing “what-if” scenarios;
querying a plurality of pre-stored events and detecting a hazardous event with simulation; and
assessing a risk of an aircraft operation and determining a probability of a reoccurrence of a detected event.

11. The computer readable medium of claim 10, further comprising further program instructions for displaying and replaying the detected event in a three-dimensional view.

12. The computer readable medium of claim 10, further comprising further program instructions for identifying, evaluating and implementing alternatives for mitigating the risk.

13. The computer readable medium of claim 8, further comprising further program instructions for alerting ground staff if an emergency situation, occurs.

14. The computer readable medium of claim 13, further comprising further program instructions for setting landing priorities to expedite a safe landing.

15. A method for evaluating and recording data, which comprises the steps of:
receiving signals containing data from a plurality of aircraft;
determining normal thresholds for the data;
monitoring and analyzing the data; and
generating an alert signal if the data is beyond the normal thresholds with a ground based computer terminal in real time.

16. The method according to claim 15, which comprises monitoring and analyzing the data from at least 1000 aircraft simultaneously.

17. The method according to claim 16, which comprises utilizing the data to prevent disasters.

18. The method according to claim 15, which comprises processing an in-flight recorded data online in a world wide web environment and making a change to minimize risk and prevent accidents.

19. A computer readable medium having program instructions for performing a method for recording data from an aircraft and alerting with a wireless network, comprising:
receiving signals containing data from a plurality of aircraft;
determining normal thresholds for the data;
monitoring and analyzing the data; and
generating an alert signal if the data is beyond the normal thresholds with a ground based computer terminal in real time.

20. The computer readable medium according to claim 19, further comprising further program instructions for transmitting the data to the ground control facility connected in an Internet environment.

21. The computer readable medium of claim 19, further comprising further program instructions for capturing and generating video data, audio data, and flight data.

22. The computer readable medium of claim 19, further comprising further program instructions for utilizing the data to prevent disasters.

23. A system for transmitting and recording data from an aircraft and alerting in real time, comprising:
a transmission unit for transmitting data, said transmission unit including:
audio/video recorder for recording the data;
at least one video camera strategically disposed in the aircraft and connected to said audio/video recorder; and
a multiplexer coupled to said audio/video recorder.

24. The system according to claim 23, further comprising at least one satellite coupled to said transmission unit for transmitting the data.

25. The system according to claim 23, further comprising a flight data recorder and a cockpit voice recorder coupled to said transmission unit and recording further data to be transmitted.

26. The system according to claim 23, further comprising a microphone coupled to said transmission unit.

27. The system according to claim 23, further comprising a ground computer having a monitor and coupled to said transmission unit in real time for receiving the data.

28. The system according to claim 27, wherein said ground computer includes a storage device for storing the data.

29. The system according to claim 23, further comprising a storage device coupled to said transmission unit in real time for storing the data.

30. The system according to claim 23, further comprising a cell phone coupled to said transmission unit.

31. The system according to claim 25, further comprising:
a decompression multiplexer coupled to said transmission unit and receiving the data, said decompression multiplexer decompressing the data resulting in decompressed data; and
a computer with a storage device, said computer connected to said decompression multiplexer and receiving the decompressed data, said computer programmed to evaluate the decompressed data and to output an alert if the decompressed data is not within a predefined threshold.

32. The system according to claim 31, wherein the decompressed data includes at least one of velocity information, altitude information, fuel quantity information, engine RPM information, rudder position information, wing flap position information, aileron position information, flight path and flight location information, landing gear position information, aircraft video data, and voice data.

33. A method for transmitting and recording data from an aircraft and alerting with a wireless network, which comprises the steps of:
capturing and generating data of an event or condition of the aircraft in real time; and
transmitting the data to a ground control facility in real time.

34. The method according to claim 33, which comprises storing the data.

35. The method according to claim 33, which comprises:
determining a normal threshold for the data; and
generating an alert signal if the data is beyond the threshold with a ground based computer terminal in real time.

36. The method according to claim 33, wherein the ground controls facility is connected in an Internet environment.

37. The method according to claim 35, which comprises alerting ground staff if the normal threshold for the data is violated.

38. The method according to claim 33, which comprises:
monitoring the data by ground staff in real time; and
analyzing the data for an occurrence of any abnormal event or condition.

39. The method according to claim 33, which comprises capturing and generating video data, audio data, and flight data.

40. The method according to claim 33, which comprises utilizing the data to prevent disasters.

41. A system for recording data from an aircraft and alerting with a wireless network, which comprises:
a ground-based computer;
means for receiving signals containing data from a plurality of aircraft;
means for determining normal thresholds for the data;
means for monitoring and analyzing the data; and
means for generating an alert signal if the data is beyond the normal thresholds and said ground-based computer in real time animating pilot cockpit instruments panel in response to the alert signal.
